(19) United States
(12) Patent Application Publication
(10) Pub. No.: US 2006/0091110 A1
(43) Pub. Date: May 4, 2006

(54) Cleaning solution and method for cleaning semiconductor device by using the same

(76) Inventor: Kee-Joon Oh, Kyoungki-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,831

(22) Filed: Dec. 30, 2004

(30) Foreign Application Priority Data
Nov. 2, 2004 (KR) 2004-88452

(51) Int. Cl. B44C 1/22; C23G 1/00; C23F 1/00

(52) U.S. Cl. 216/83; 252/79.1; 134/2

(57) ABSTRACT

The present invention provides a cleaning solution and a method for cleaning a semiconductor device by the same capable of preventing damages on a tungsten layer from the cleaning solution and removing particles. The cleaning solution includes a deionized water-based ammonia solution; a surfactant added to the ammonia solution; and a chelating agent added to the ammonia solution. The method includes the steps of: depositing a photoresist layer on an upper portion of a substrate provided with a conductive layer including at least a tungsten layer; forming a photoresist pattern by patterning the photoresist layer; forming a conductive pattern by etching the conductive layer with use of the photoresist pattern as an etch mask; removing the photoresist pattern; and performing a cleaning process to the substrate provided with the conductive pattern by using a cleaning solution of a deionized water-based ammonia solution added with a surfactant and a chelating agent.

### FIELD OF THE INVENTION

The present invention relates to a technology for fabricating a semiconductor device; and more particularly, to a cleaning solution and a method for cleaning a semiconductor device by using the same.

Description of Related Arts

In a process for fabricating a semiconductor device, contaminants that contaminate a wafer are various with a variety of kinds such as an organic matter, an inorganic matter, a metal ion and a natural oxide layer. Also, kinds of defects caused by the above listed contaminants are various from a critical defect to a pattern defect.

Accordingly, a cleaning technology capable of effectively removing these contaminants is required to fabricate a semiconductor device with high reliability.

In general, cleaning solutions used for a cleaning process use acidic and alkaline chemicals. However, it is difficult to apply the cleaning solutions to metals. Particularly, in case of applying aluminum (Al) to a multi level metal (MLM) process, it is difficult to use the cleaning solutions without any other processes because Al is very weak to acidity and alkalinity.

Accordingly, during a cleaning process performed after a process using the metal, a solvent chemical is used and particularly, an amine based organic chemical is used.

However, as is well known, the amine based organic chemical does not have a capability of removing particles.

Accordingly, for removing the particles produced by the process applicable to the metal, a scrubbing method which is a physical method cannot help being used. However, this scrubbing method causes a damage on a pattern as the scrubbing method physically proceeds.

Recently, for improving a low resistance and a speed of a signal processing, a process using tungsten (W) as a gate electrode is introduced so that a cleaning process performed after etching W is very important as well as a process for etching W. During the process using W, a chemical used for the cleaning process is either a mixed solution of H₂SO₄ and H₂O₂ or a mixed solution of NH₄OH and H₂O₂.

FIG. 1 is a flow chart illustrating a conventional method for fabricating a gate electrode of a semiconductor device using a cleaning solution.

Referring to FIG. 1, the method for fabricating the gate electrode includes steps of forming a gate insulation layer 11, forming a gate conductive layer including a W layer 12, depositing a photoresist layer 13, forming a photoresist pattern 14, etching the gate conductive layer 15, removing the photoresist layer 16, performing a first cleaning process by using a cleaning solution formed by mixing H₂SO₄ and H₂O₂ 17, performing a second cleaning process using buffered oxide etchant (BOE) solution 18 wherein the BOE is a mixed cleaning solution of NH₄F and HF, and performing a third cleaning process using a cleaning solution of a deionized water-based ammonia solution added with H₂O₂ 19.

As described above, the conventional method for fabricating the gate electrode uses the W layer and the cleaning solution formed by mixing NH₄OH, H₂O₂ and the deionized water for the last cleaning process after etching the W layer, thereby removing particles.

However, in case of using the W layer as the gate electrode in accordance with the conventional method, there is a problem of causing a damage on the W layer by the cleaning solution used for the cleaning process. Particularly, since the W layer is melted by H₂O₂ which is one of the compositions of the cleaning solution used for the second cleaning process, it is impossible to use the W layer as the gate electrode.

If the W layer is melted, it is impossible to remove the particles remaining on a surface of the W layer after etching the W layer.

This problem can be possibly happen during all of the processes for fabricating semiconductor devices using the W layer.

### SUMMARY OF THE INVENTION

It is, therefore, an object of the present invention to provide a cleaning solution and a method for cleaning a semiconductor device by the same capable of preventing damages on a tungsten layer from the cleaning solution and removing particles.

In accordance with one aspect of the present invention, there is provided a cleaning solution, including: a deionized water-based ammonia solution; a surfactant added to the ammonia solution; and a chelating agent added to the ammonia solution.

In accordance with another aspect of the present invention, there is provided a method for cleaning a semiconductor device, including the steps of: forming a photoresist layer on an upper portion of a substrate provided with a conductive layer including at least a tungsten layer; forming a photoresist pattern by patterning the photoresist layer; forming a conductive pattern by etching the conductive layer with use of the photoresist pattern as an etch mask; removing the photoresist pattern; and performing a cleaning process to the substrate provided with the conductive pattern by using a cleaning solution of a deionized water-based ammonia solution added with a surfactant and a chelating agent.

In accordance with further aspect of the present invention, there is provided a method for cleaning a semiconductor device, including the steps of: depositing a photoresist layer on an upper portion of a substrate provided with a conductive layer including at least a tungsten layer; forming a photoresist pattern by patterning the photoresist layer; forming a conductive pattern by etching the conductive layer with use of the photoresist pattern as an etch mask; removing the photoresist pattern; performing a first cleaning process to the substrate provided with the conductive pattern by using a cleaning solution formed by mixing H₂SO₄ and H₂O₂; performing a second cleaning process to the substrate finished with the first cleaning process by using a buffered oxide etchant (BOE) solution; and performing a third cleaning process to the substrate finished with the second cleaning process by using a cleaning solution of a deionized water-based ammonia solution added with a surfactant and a chelating agent.

### BRIEF DESCRIPTION OF THE DRAWINGS

The above and other objects and features of the present invention will become better understood with respect to the following description of the preferred embodiments given in conjunction with the accompanying drawings, in which:

FIG. 1 is a flow chart illustrating a conventional method for cleaning a semiconductor device;

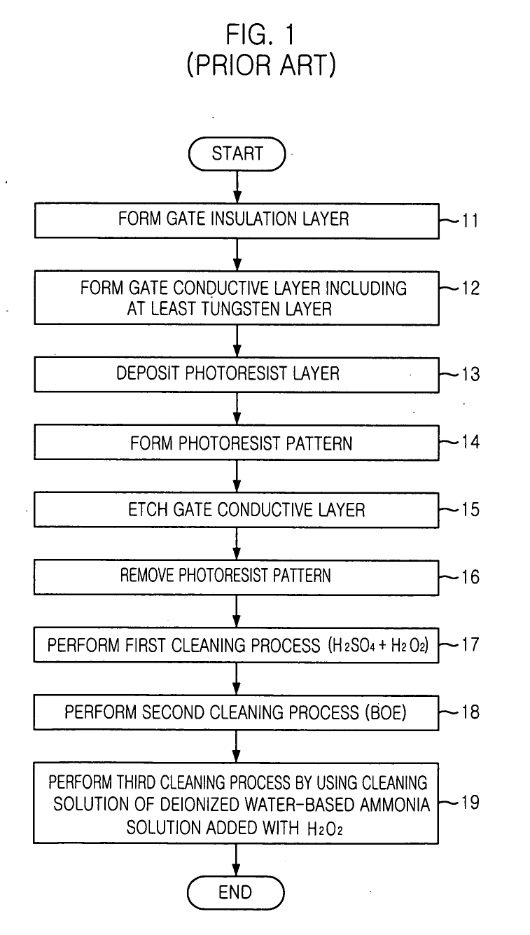

FIG. 2 is a flow chart illustrating a method for cleaning a semiconductor device in accordance with a first embodiment of the present invention; and

FIG. 3 is a flow chart illustrating a method for cleaning a semiconductor device in accordance with a second embodiment of the present invention.

### DETAILED DESCRIPTION OF THE INVENTION

Hereinafter, detailed descriptions on preferred embodiments of the present invention will be provided with reference to the accompanying drawings.

A cleaning solution in accordance with preferred embodiments of the present invention is comprised of NH₄OH, deionized water, a surfactant and a chelating agent.

First, NH₄OH and the deionized water make the cleaning solution maintain an alkaline property, thereby keeping a zeta potential between a wafer and particles in a negative charge. Accordingly, NH₄OH and the deionized water make the particles not to be adhered by a repulsion of the particles based on an electric double layer repulsion force.

The surfactant serves a role in keeping all of the wafer and the particles in a surface negative charge for improving the repulsion of the particles and the chelating agent serves a role in improving a passivation layer for protecting a tungsten (W) layer which is a metal from the cleaning solution.

In the cleaning solution, the ammonia solution is formed by mixing NH₄OH and the deionized water in a ratio of approximately 150 to 200 parts of NH₄OH to approximately 1 part of the deionized water. At this time, a pH factor is maintained from approximately 10 to approximately 11. The surfactant is mixed in an amount ranging from approximately 0.01 volume % to approximately 0.05 volume % with respect to the cleaning solution. The chelating agent is mixed in an amount ranging from approximately 0.01 volume % to approximately 0.05 volume % with respect to the cleaning solution. In the result, a mixing ratio of the cleaning solution, i.e., a ratio of NH₄OH:H₂O:the surfactant:the chelating agent, becomes a ratio of approximately 150˜200:1 approximately 0.01˜0.05:approximately 0.01˜0.05. This cleaning solution is maintains in a temperature ranging from approximately 40° C. to approximately 70° C.

Meanwhile, in the cleaning solution, the surfactant uses a polyethylene glycol and the chelating agent uses an ethylene diamine tetraacetic acid (EDTA).

As mentioned above, a removal of the particles by using the cleaning solution of the present invention is explained with a relationship between the zeta potential and the pH factor showing a hydrogen ion concentration of the cleaning solution used for cleaning the wafer. If the cleaning solution is an acidic solution, the particles including metal contaminants mainly show a positive zeta potential. As the cleaning solution becomes to have more alkaline property, the cleaning solution is then shifted to have a negative zeta potential. Hence, there generates a reciprocal repulsion between a surface of the wafer and the particles, thereby minimizing a contamination. Accordingly, NH₄OH is included in the cleaning solution formed based on the deionized water in accordance with the present invention.

A method for cleaning a semiconductor device by using the cleaning solution described above in accordance with the present invention will be explained, hereinafter.

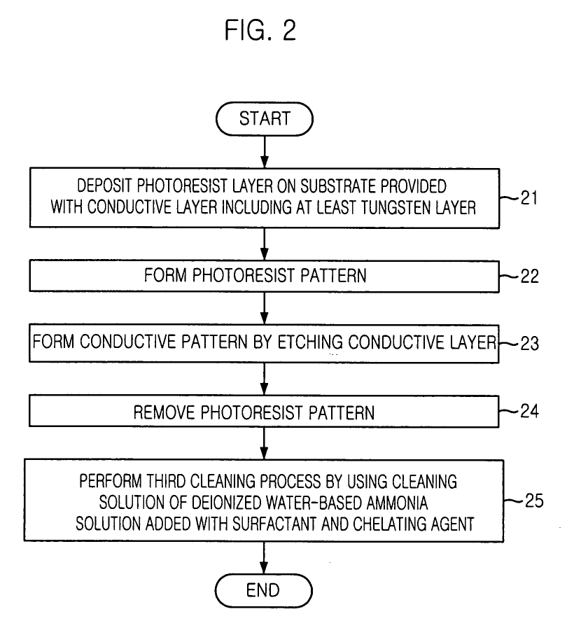

FIG. 2 is the method for cleaning the semiconductor device in accordance with a first embodiment of the present invention.

Referring to FIG. 2, the method for cleaning the semiconductor device includes steps of depositing a photoresist layer on an upper portion of a substrate provided with a conductive layer including at least a tungsten (W) layer 21, for forming a photoresist pattern 22, forming a conductive pattern by etching the conductive layer 23, removing the photoresist pattern 24, and performing a cleaning process by using a cleaning solution of a deionized water-based ammonia solution added with a surfactant and a chelating agent 25.

First, the step of depositing the photoresist layer is a step of depositing the photoresist layer on the upper portion of the conductive layer after forming the conductive layer including at least the W layer, i.e., a stack of a polysilicon layer and the W layer.

The step of forming the photoresist pattern 22 is a step of forming the photoresist pattern serving a role of a mask by performing a photo-exposure process and a developing process to the deposited photoresist layer.

The step of forming the photoresist pattern 23 is a step of etching the conductive layer by using the photoresist pattern as an etch mask and the step of removing the photoresist pattern 24 is a step of stripping the photoresist pattern remaining after etching the conductive layer. Herein, the photoresist pattern is stripped by using an oxygen plasma as well known.

The step of performing the cleaning process by using the cleaning solution of the deionized water-based ammonia solution added with the surfactant and the chelating agent 25 is a step of cleaning the substrate provided with the conductive pattern by using the cleaning solution of the deionized water-based ammonia solution added with the surfactant and the chelating agent after removing the photoresist pattern, wherein the ammonia solution is a mixed solution of NH₄OH and H₂O.

In FIG. 2, the step of performing the cleaning process 25 proceeds in a single wafer tool. The single wafer tool is not a cleaning method dipping the wafer into a bath but a cleaning method spraying the cleaning solution as spinning the wafer.

In the cleaning solution, NH₄OH and the deionized water comprising the ammonia solution are mixed in a ratio of approximately 150 to approximately 200 of NH₄OH and 1 part of the deionized water. At this time, the pH factor is maintained from approximately 10 to approximately 11. The surfactant is mixed in an amount ranging from approximately 0.01 volume % to approximately 0.05 volume % with respect the cleaning solution. The chelating agent is mixed in an amount ranging from approximately 0.01 volume % to approximately 0.05 volumes % with respect to the cleaning solution. This cleaning solution is maintained in a temperature ranging from approximately 40° C. to approximately 70° C.

In the cleaning solution, the surfactant uses the polyethylene glycol and the chelating agent uses the EDTA.

During performing the cleaning process in the single wafer tool, i.e., a single wafer spinning device, a spinning speed ranges from approximately 800 rpm to approximately 1,000 rpm and a cleaning period ranges from approximately 30 seconds to approximately 120 seconds.

Hereinafter, a mechanism of the cleaning process using the cleaning solution having the described compositions will be explained.

First, the conductive pattern is formed and then, the photoresist pattern is removed. Afterwards, the W layer of the conductive pattern is exposed and the substrate in which great quantities of the particles are generated is put in the single wafer spinning device. Thereafter, the cleaning process is performed by spraying the cleaning solution formed by mixing NH₄OH, the deionized water, the polyethylene glycol and the EDTA.

Herein, NH₄OH and H₂O are dissolved into NH₄⁺, OH⁻, H⁺ and OH⁻ through the following chemical reaction, thereby remaining in the cleaning solution.
NH₄OH+H₂O→NH₄⁺+OH⁻H⁺+OH⁻

As explained above, if a result finished with an etching process is exposed to the cleaning solution, the EDTA which is the chelating agent of the cleaning solution reacts with the particles remaining on a surface of the W layer of the conductive pattern, thereby forming a complex compound. At this time, the complex compound serves a role in protecting the W layer from an attack of the cleaning solution.

The polyethylene glycol which is the surfactant of the cleaning solution isolates the complex compound remaining on the surface of the W layer, thereby removing the particles. In detail, the complex compound, OH⁻ of the cleaning solution and the polyethylene glycol react with each other so that the complex compound is removed from the surface of the W layer without causing any damages on the W layer.

As described above, the present invention does not use H₂O₂ mainly used for the cleaning solution during the cleaning process performed after forming the conductive pattern, thereby preventing the damages on the W layer caused by H₂O₂. Furthermore, it is possible to remove the particles by adding the surfactant and the chelating agent.

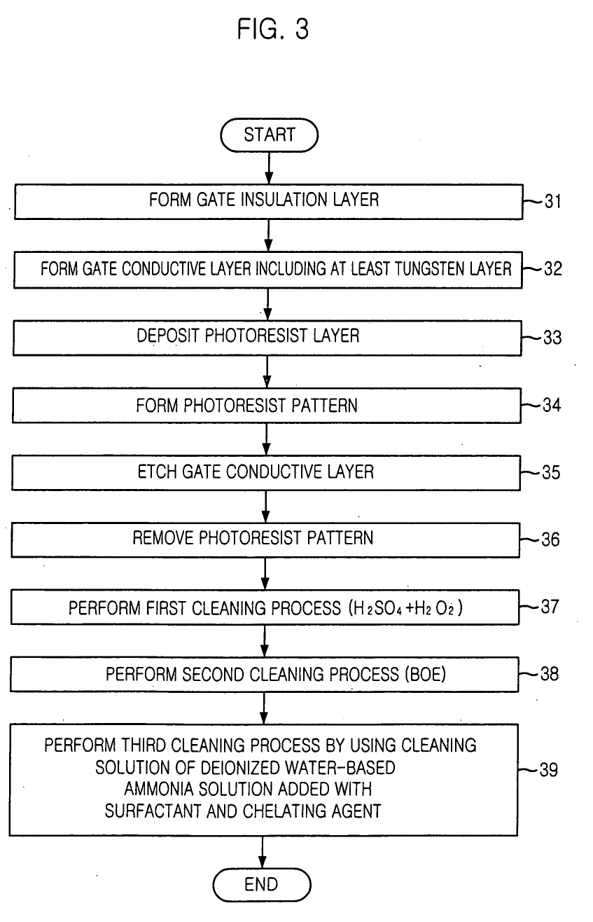

FIG. 3 is a flow chart illustrating a method for cleaning a semiconductor device in accordance with a second embodiment of the present invention.

Referring to FIG. 3, the method for cleaning the semiconductor device largely includes steps of forming a gate insulation layer 31, forming a gate conductive layer including at least a W layer 32, depositing a photoresist layer 33, forming a photoresist pattern 34, etching the gate conductive layer 35, removing the photoresist pattern 36, performing a first cleaning process by using a cleaning solution formed by mixing H₂SO₄ and H₂O₂ 37, performing a second cleaning process by using a BOE solution 38 and performing a third cleaning process by using a cleaning solution of a deionized water-based ammonia solution added with a surfactant and a chelating agent 39, wherein the BOE solution is formed by mixing NH₄F and HF.

First, the step of forming the gate insulation layer 31 is a step of forming the gate insulation layer by performing a thermal oxidation process to an upper portion of a substrate and the step of forming the gate conductive layer 32 is a step of stacking a polysilicon layer and the W layer on the gate insulation layer. Herein, a tungsten nitride layer which is a diffusion barrier material can be formed between the polysilicon layer and the W layer. Also, it is possible to stack a silicon nitride layer which is a gate hard mask on the W layer.

The steps of depositing the photoresist layer 33 and forming the photoresist pattern 34 are steps of depositing the photoresist layer on the gate conductive layer, patterning the photoresist layer by a photo-exposure process and a developing process and forming the photoresist pattern serving a role of an etch mask during forming a gate electrode.

The step of etching the gate conductive layer 35 is a step of etching the gate conductive layer by using the photoresist pattern as the etch mask and then, forming the gate electrode. Through this etching process, the W layer is exposed and great quantities of the particles are adhered on a surface of the W layer.

The step of removing the photoresist pattern 36 is a step of, stripping the photoresist pattern remaining after etching the gate conductive layer by using an oxygen plasma.

The step of performing the first cleaning process 37 is for removing contaminants, e.g., copper, adhered on the substrate through various processes. Accordingly, the step of performing the first cleaning process proceeds by using the cleaning solution formed by mixing H₂SO₄ and H₂O₂.

The step of performing the second cleaning process 38 is for removing a natural oxide layer and proceeds by using the BOE solution which is an oxide layer etch solution.

Lastly, the step of performing the third cleaning process 39 is for the purpose of removing the particles adhered on the surface of the gate electrode, particularly the W layer, and proceeds by using the cleaning solution of the deionized water-based ammonia solution added with the surfactant and the chelating agent, wherein the ammonia solution is formed by mixing NH₄OH and H₂O.

The step of performing the first cleaning process 37 and the step for performing the second cleaning process 38 proceed in an immersion type wet bath and the step of performing the third cleaning process 39 proceeds in the single wafer tool. The single wafer tool means a cleaning method for spraying the cleaning solution as spinning the wafer differently from the cleaning method used for the steps of performing the first and the second cleaning processes.

The step of performing the third cleaning process 39 is same as the step of performing the third cleaning process shown in FIG. 2. In the cleaning solution, NH₄OH and H₂O comprising the ammonia solution are mixed in a ratio of approximately 150 to approximately 200 parts of NH₄OH to 1 part of H₂O. At this time, the pH factor is maintained from approximately 10 to approximately 11. The surfactant is mixed in an amount ranging form approximately 0.01 volume % to approximately 0.05 volume % with respect to the cleaning solution. The chelating agent is mixed in an amount ranging form approximately 0.01 volume % to approximately 0.05 volume % with respect to the cleaning solution. In the result, a mixing ratio of the cleaning solution, i.e., NH₄OH:H₂O:the surfactant:the chelating agent, becomes a ratio of approximately 150˜200:1:approximately 0.01˜0.05 approximately 0.01˜0.05. The cleaning solution is maintained in a temperature ranging from approximately 40° C. to approximately 70° C. The surfactant of the cleaning solution uses the polyethylene glycol and the chelating agent of the cleaning solution uses the EDTA. When the cleaning process proceeds in the single wafer tool, i.e., the single wafer spinning device, a spinning speed ranges from approximately 800 rpm to approximately 1,000 rpm and a cleaning period ranges from approximately 30 seconds to approximately 120 seconds.

A mechanism of the cleaning process using the above described compositions is same as the mechanism of the cleaning process shown in FIG. 2.

As shown in FIGS. 2 and 3, the present invention uses the cleaning solution of the ammonia solution added with the surfactant and the chelating agent during the cleaning process performed after etching the conductive layer including the W layer, thereby easily removing the particles without causing any damages on the W layer included in the conductive layer.

The present invention performs a cleaning process by using a cleaning solution formed by mixing NH₄OH, H₂O₂, a surfactant and a chelating agent, thereby easily removing particles without causing any damages on a tungsten layer and improving yields of products.

The present application contains subject matter related to the Korean patent application No. KR 2004-0088452, filed in the Korean Patent Office on Nov. 2, 2004, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

What is claimed is:

1. A cleaning solution, comprising:
a deionized water-based ammonia solution;
a surfactant added to the ammonia solution; and
a chelating agent added to the ammonia solution.

2. The method of claim 1, wherein the chelating agent uses an ethylene diamine tetraacetic acid (EDTA).

3. The method of claim 1, wherein a concentration of adding the chelating agent ranges from approximately 0.01 volume % to approximately 0.05 volume % with respect to the cleaning solution.

4. The method of claim 1, wherein the surfactant uses a polyethylene glycol.

5. The method of claim 1, wherein a concentration of adding the surfactant ranges from approximately 0.01 volume % to approximately 0.05 volume % with respect to the cleaning solution.

6. The method of claim 1, wherein the ammonia solution is formed by mixing NH₄OH and the deionized water in a ratio of approximately 150 to approximately 200 parts of NH₄OH to 1 part of the deionized water.

7. A method for cleaning a semiconductor device, comprising the steps of:
forming a photoresist layer on an upper portion of a substrate provided with a conductive layer including at least a tungsten layer;
forming a photoresist pattern by patterning the photoresist layer;
forming a conductive pattern by etching the conductive layer with use of the photoresist pattern as an etch mask;
removing the photoresist pattern; and
performing a cleaning process to the substrate provided with the conductive pattern by using a cleaning solution of a deionized water-based ammonia solution added with a surfactant and a chelating agent.

8. The method of claim 7, wherein the chelating agent is added in an amount ranging from approximately 0.01 volume % to approximately 0.05 volume % with respect to the cleaning solution.

9. The method of claim 8, wherein the chelating agent uses an ethylene diamine tetraacetic acid (EDTA).

10. The method of claim 7, wherein the surfactant is added in an amount ranging from approximately 0.01 volume % to approximately 0.05 volume % with respect to the cleaning solution.

11. The method of claim 10, wherein the surfactant uses a polyethylene glycol.

12. The method of claim 7, wherein the ammonia solution of the cleaning solution is formed by mixing NH₄OH and the deionized water in a ratio of approximately 150 to approximately 200 parts of NH₄OH to 1 part of the deionized water.

13. The method of claim 7, wherein the cleaning process proceeds in a single wafer spinning device.

14. The method of claim 13, wherein a spinning speed of the single wafer spinning device ranges from approximately 800 rpm to approximately 1,000 rpm.

15. The method of claim 14, wherein the cleaning process is performed for a period ranging from approximately 30 seconds to approximately 120 seconds.

16. The method of claim 7, wherein the cleaning solution is maintained in a temperature ranging from approximately 40° C. to approximately 70° C.

17. A method for cleaning a semiconductor device, comprising the steps of:
depositing a photoresist layer on an upper portion of a substrate provided with a conductive layer including at least a tungsten layer;
forming a photoresist pattern by patterning the photoresist layer;
forming a conductive pattern by etching the conductive layer with use of the photoresist pattern as an etch mask;
removing the photoresist pattern;
performing a first cleaning process to the substrate provided with the conductive pattern by using a cleaning solution formed by mixing H₂SO₄ and H₂O₂;
performing a second cleaning process to the substrate finished with the first cleaning process by using a buffered oxide etchant (BOE) solution; and
performing a third cleaning process to the substrate finished with the second cleaning process by using a cleaning solution of a deionized water-based ammonia solution added with a surfactant and a chelating agent.

18. The method of claim 17, wherein at step of performing the third cleaning process, the chelating agent is added in an amount ranging from approximately 0.01 volume % to approximately 0.05 volume % with respect to the cleaning solution.

19. The method of claim 18, wherein the chelating agent uses an ethylene diamine tetraacetic acid (EDTA).

20. The method of claim 17, wherein at the step of performing the third cleaning process, the surfactant is added in an amount ranging from approximately 0.01 volume % to approximately 0.05 volume % with respect to the cleaning solution.

21. The method of claim 17, wherein the surfactant uses a polyethylene glycol.

22. The method of claim 17, wherein at the step of performing the third cleaning process, the ammonia solution of the cleaning solution is formed by mixing NH₄OH and the deionized water in a ratio of approximately 150 to approximately 200 parts of NH₄OH to 1 part of the deionized water.

23. The method of claim 17, wherein the first and the second cleaning processes proceed in a wet bath and the third cleaning process proceeds in a single wafer spinning device.

24. The method of claim 23, wherein at the step of performing the third cleaning process, a spinning speed of the single wafer spinning device range from approximately 800 rpm to approximately 1,000 rpm.

25. The method of claim 24, wherein the third cleaning process is performed for a period ranging from approximately 30 seconds to approximately 120 seconds.

26. The method of claim 17, wherein at the step of performing the third cleaning process, a temperature of the cleaning solution is maintained in a temperature ranging from approximately 40° C. to approximately 70° C.
